(19) United States
(12) Patent Application Publication
(10) Pub. No.: US 2025/0289211 A1
(43) Pub. Date: Sep. 18, 2025

(54) MULTI-LAYERED ARTICLE

(71) Applicant: BOREALIS AG, Vienna (AT)

(72) Inventors: Jingbo WANG, Linz (AT); Friedrich BERGER, Linz (AT); Arnaud ALABRUNE, Courbevoie (FR); Chantal SEMAAN, Barcelona (ES)

(21) Appl. No.: 18/855,698

(22) PCT Filed: Apr. 6, 2023
(86) PCT No.: PCT/EP2023/059090

§ 371 Date: Oct. 10, 2024

(30) Foreign Application Priority Data
Apr. 11, 2022 (EP) 22167538.2

(51) Int. Cl. B32B 27/32; B29C 48/00; B29C 48/08; B29C 48/21; B29K 23/00; B29L 9/00; B32B 5/14; B32B 7/12; B32B 27/08; B32B 27/16; B32B 37/12; B32B 37/14

(52) U.S. Cl. CPC B32B 27/327; B29C 48/0017; B29C 48/022; B29C 48/08; B29C 48/21; B32B 5/145; B32B 7/12; B32B 27/08; B32B 37/12; B29K 2023/0633; B29K 2023/065; B29K 2023/08; B29K 2995/0012; B29K 2995/0051; B29K 2995/0063; B29L 2009/00; B32B 27/16; B32B 2037/148; B32B 2250/02; B32B 2250/242; B32B 2307/30; B32B 2307/40; B32B 2307/516; B32B 2307/558; B32B 2307/72; B32B 2307/7376; B32B 2310/14; B32B 2323/043; B32B 2323/046; B32B 2355/00; B32B 2439/70; B32B 2439/80

(57) ABSTRACT

The present invention relates to a multi-layered article comprising at least a specific oriented polyethylene-based film (OPEF) and a specific non-oriented polyethylene-based film (NOPEF). Furthermore, the present invention relates to a method for producing said article and its use as a packaging material.

The present invention relates to a multi-layered article comprising at least a specific oriented polyethylene-based film (OPEF) and a specific non-oriented polyethylene-based film (NOPEF). Furthermore, the present invention relates to a method for producing said article and its use as packaging material.

Polyethylenes are widely used everywhere in daily life, like packaging, due to their excellent cost/performance ratios. Due to the different requirements nowadays multi-layered articles with different type of materials are used, which from one side serve the needs, but have the disadvantage that recycling of these articles is difficult. From a recycling point of view, mono-material solutions would be preferred. At the same time the performance of the materials should not diminish.

Mono-material solutions are already known in the prior art.

EP 0 575 465 A1 relates to heat sealable compositions suitable for film and film structures comprising: (a) from 30 to 70 weight percent of a low melting polymer comprising an ethylene based copolymer having a density of from 0.88 g/cm³ to 0.915 g/cm³, a melt index of from 1.5 dg/min to 7.5 dg/min, a molecular weight distribution no greater than 3.5, and a composition distribution breath index greater than 70 percent; and, (b), being different from (a), from 70 to 30 weight percent of a propylene based polymer having from 88 mole percent to 100 mole percent propylene and from 12 mole percent to 0 mole percent of an alpha-olefin other than propylene.

WO 2012/061168 A1 relates to a sealant composition, a method of producing the same, articles made therefrom, and a method for forming such articles. The sealant composition according to the present invention comprises: (a) from 70 to 99.5 percent by weight of an ethylene/alpha-olefin interpolymer composition, based on the total weight of the sealant composition, wherein said ethylene/alpha-olefin interpolymer composition comprises an ethylene/alpha-olefin interpolymer, wherein the ethylene/alpha-olefin interpolymer has a Comonomer Distribution Constant (CDC) in the range of from 15 to 250, and a density in the range of from 0.875 to 0.963 g/cm³, a melt index (12) in a range of from 0.2 to 20 g/10 minutes, and long chain branching frequency in the range of from 0.02 to 3 long chain branches (LCB) per 1000C; (b) from 0.5 to 30 percent by weight of a propylene/alpha-olefin interpolymer composition, wherein said propylene/alpha-olefin interpolymer composition comprises a propylene/alpha-olefin copolymer or a propylene/ethylene/butene terpolymer, wherein said propylene/alpha-olefin copolymer has a crystallinity in the range of from 1 percent by weight to 30 percent by weight, a heat of fusion in the range of from 2 Joules/gram to 50 Joules/gram, and a DSC melting point in the range of 25° C. to 110° C.

WO 2019/005930 A1 refers to laminate structures for flexible packaging comprising a print film comprising an ethylene-based polymer, a sealant film laminated to the print film, wherein the sealant film comprising at least 3 layers and has an overall thickness from 15 to 30 μm. The sealant film comprises a middle layer, an outer layer, and an inner layer disposed between the print film and the middle layer. The inner layer comprises an ethylene interpolymer having a density from 0.910 to 0.925 g/cc and a melt index (12) from 0.5 to 5 g/10 min, and at least one of the inner layer, the middle layer, and the outer layer comprise a first composition comprising at least one ethylene based polymer, wherein the first composition comprises a Molecular Weighted Comonomer Distribution Index (MWCDI) value greater than 0.9, and a melt index ratio (I10/I2) that meets the equation: I10I2≥7.0-log (12).

Starting therefrom, it is one objective of the present invention to provide a multi-layered article which is not only easy to recycle but has also good balance of mechanical, optical and sealing properties.

These objects have been solved by the multi-layered article according to claim 1 comprising at least an oriented polyethylene-based film (OPEF) and a non-oriented polyethylene-based film (NOPEF), wherein the non-oriented polyethylene-based film (NOPEF) comprises at least the following sublayers: i) a skin layer (SKL); ii) a core layer (CL); and iii) a sealing layer (SL); wherein the sealing layer comprises a metallocene-catalysed multimodal polyethylene copolymer (P), which consists of 30.0 to 70.0 wt.-% of an ethylene-1-butene polymer component (A), and 30.0 to 70.0 wt.-% of an ethylene-1-hexene polymer component (B), wherein the ethylene-1-butene polymer component (A) has a density (ASTM D792) in the range of 920 to 950 kg/m³; a MFR₂ (190° C., 2.16 kg, ISO 1133) in the range of 2.0 to 200 g/10 min; and a 1-butene content in the range of 0.5 to 5.0 wt.-%, based on the ethylene-1-butene polymer component (A); and the ethylene-1-hexene polymer component (B) has a density (ASTM D792) in the range of 880 to 915 kg/m³; an MFR₂ (190° C., 2.16 kg, ISO 1133) in the range of 0.01 to 1.5 g/10 min; and a 1-hexene content in the range of 15.0 to 25.0 wt.-% based on the ethylene-1-hexene polymer compound (B); wherein the multimodal polyethylene copolymer (P) has a density (ASTM D792) in the range of 905 to 915 kg/m³; an MFR₂ (190° C., 2.16 kg, ISO 1133) in the range of 0.5 to below 2.0 g/10 min; and a ratio of the MFR₂₁ (190° C., 21.6 kg, ISO 1133) to MFR₂ (190° C., 2.16 kg, ISO 1133), MFR₂₁/MFR₂, in the range of 22 to 70.

Advantageous embodiments of the multi-layered article in accordance with the present invention are specified in the dependent claims 2 to 13.

The present invention further relates in accordance with claim 14 to a method for manufacturing the multi-layered article. Claim 15 relates to the use of the article according to the present invention as packaging material.

### DEFINITIONS

A metallocene-catalysed linear low density polyethylene is defined in this invention as a linear low density polyethylene copolymer, which has been produced in the presence of a metallocene catalyst.

A Ziegler-Natta-catalysed linear low density polyethylene is defined in this invention as a linear low density polyethylene copolymer, which has been produced in the presence of a Ziegler-Natta catalyst.

For the purpose of the present invention the metallocene-catalysed linear low density polyethylene consisting of an ethylene-1-butene polymer component (A) and an ethylene-1-hexene polymer component (B) means that the polymer is produced in an at least 2-stage sequential polymerization process, wherein first component (A) is produced and component (B) is then produced in the presence of component (A) in a subsequent polymerization step, yielding the metallocene-catalysed linear low density polyethylene or vice versa, i.e. first component (B) is produced and component (A) is then produced in the presence of component (B) in a subsequent polymerization step, yielding the metallocene-catalysed linear low density polyethylene.

The term “multimodal” in context of multimodal metallocene-catalysed linear low density polyethylene means herein multimodality with respect to melt flow rate (MFR) of at least the ethylene polymer components (A) and (B), i.e. the ethylene polymer components (A) and (B), have different MFR values. The multimodal metallocene-catalysed linear low density polyethylene can have further multimodality between the ethylene polymer components (A) and (B) with respect to one or more further properties, like density, comonomer type and/or comonomer content, as will be described later below.

Low density polyethylene (LDPE) is defined in this invention as low density polyethylene copolymer, which has been preferably produced in a high-pressure process.

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

### Metallocene-Catalysed Multimodal Polyethylene Copolymer (P)

The sealing layer of the multi-layered article according to the present invention comprises a specific metallocene-catalysed multimodal polyethylene copolymer (P). The other layers may also comprise said copolymer (P).

The metallocene-catalysed multimodal polyethylene copolymer (P) consists of (i) 30.0 to 70.0 wt.-% of an ethylene-1-butene polymer component (A), and (ii) 70.0 to 30.0 wt.-% of an ethylene-1-hexene polymer component (B).

In a preferred embodiment of the present invention, the ethylene-1-butene polymer component (A) consists of an ethylene polymer fraction (A-1) and (A-2).

In case that the ethylene-1-butene polymer component (A) consists of ethylene polymer fractions (A-1) and (A-2), the MFR₂ of the ethylene polymer fractions (A-1) and (A-2) may be different from each other.

The ethylene polymer fraction (A-1) preferably has a MFR₂ (190° C., 2.16 kg, ISO 1133) in the range of 1.0 to 200 or 3 to 300 g/10 min, preferably of 1.0 to 20.0 g/10 min, more preferably of 1.5 to 18.0 g/10 min, still more preferably of 2.0 to 16.0 g/10 min and even more preferably of 2.5 to 14.0 g/10 min, like 3.0 to 12.0 g/10 min and/or a density (ASTM D792) in the range from 920 to 960 kg/m³, preferably from 925 to 955 kg/m³ and more preferably from 930 to 950 kg/m³.

The ethylene polymer fraction (A-2) has a MFR₂ (190° C., 2.16 kg, ISO 1133) in the range of 3.0 to 200, preferably of 3.0 to 40.0 g/10 min, more preferably of 3.2 to 30.0 g/10 min, still more preferably of 3.5 to 20.0 g/10 min and most preferably of 3.5 to 10.0 g/10 min and/or a density (ASTM D792) in the range from 930 to 950 kg/m³, preferably from 935 to 945 kg/m³.

The MFR₂ of the ethylene polymer components (A) and (B) are different from each other.

The ethylene polymer component (A) has a MFR₂ (190° C., 2.16 kg, ISO 1133) in the range of 2.0 to 200, preferably of 2.0 to 40 g/10 min, more preferably of 2.5 to 30 g/10 min, still more preferably of 3.0 to 20 g/10 min and even more preferably of 3.2 to 10 g/10 min.

The ethylene polymer component (B) has a MFR₂ (190° C., 2.16 kg, ISO 1133) in the range of 0.01 to 1.5 g/10 min, preferably of 0.05 to 1.5 g/10 min, more preferably of 0.1 to 1.2 g/10 min and even more preferably of 0.2 to 1.0 g/10 min.

The MFR₂ (190° C., 2.16 kg, ISO 1133) of the multimodal copolymer (P) is in the range of 0.5 to below 2.0 g/10 min, preferably 0.8 to 1.8 g/10 min, more preferably 1.0 to 1.5 g/10 min.

The multimodal copolymer (P) has a ratio of the MFR₂₁ (190° C., 21.6 kg, ISO 1133) to MFR₂ (190° C., 2.16 kg, ISO 1133), MFR₂₁/MFR₂, in the range of from 22 to 70, preferably from 23 to 50, more preferably from 25 to 40 and still more preferably from 28 to 35.

In an embodiment of the invention it is preferred the ratio of the MFR₂ (190° C., 2.16 kg, ISO 1133) of ethylene-1-butene polymer component (A) to the MFR₂ (190° C., 2.16 kg, ISO 1133) of the final multimodal copolymer (P) is at least 2.5 to 20.0, preferably 3.0 to 15.0 and more preferably of 3.5 to 10.0.

Naturally, in addition to multimodality with respect to, i.e. difference between, the MFR₂ of ethylene polymer components (A) and (B), the multimodal PE of the invention can also be multimodal e.g. with respect to one or both of the two further properties: multimodality with respect to, i.e. difference between the comonomer content(s) present in the ethylene polymer components (A) and (B); and/or the density of the ethylene polymer components (A) and (B).

Preferably, the multimodal copolymer (P) is further multimodal with respect to the comonomer content of the ethylene polymer components (A) and (B).

The comonomer type for the polymer fractions (A-1) and (A-2) is the same, thus both fractions therefore have 1-butene as comonomer.

The comonomer content of component (A) and (B) can be measured, or, in case, and preferably, one of the components is produced first and the other thereafter in the presence of the first produced in a so called multistage process, then the comonomer content of the first produced component, e.g. component (A), can be measured and the comonomer content of the other component, e.g. component (B), can be calculated according to following equation:

$$Comonomer content ( mol - \% ) in component B = ( comonomer content ( mol - \% ) in final product - ( weight fraction of component {A}^{*} comonomer content ( mol - \% ) in component A ) ) / ( weight fraction of component B ) .$$

The total amount of 1-butene, based on the multimodal polymer (P) is preferably in the range of from 0.1 to 2.5 wt.-%, preferably 0.1 to 1.0 wt.-%, more preferably 0.2 to 0.8 wt.-% and more preferably 0.3 to 0.6 wt.-%. The total amount of 1-hexene, based on the multimodal polymer (P) preferably is in the range of 2.0 to 20.0 wt.-%, more preferably 4.0 to 18.0 wt.-% and more preferably 6.0 to 15.0 wt.-%.

The total amount of 1-butene, present in the ethylene-1-butene polymer component (A) is in the range of 0.5 to 5.0 wt.-%, preferably of 0.8 to 4.0 wt.-%, more preferably of 1.0 to 3.0 wt.-%, even more preferably of 1.0 to 2.0 wt.-%, based on the ethylene-1-butene polymer component (A).

The total amount of 1-hexene, present in the ethylene-1-hexene polymer component (B) is in the range of 15.0 to 25.0 wt.-%, preferably of 16.0 to 22.0 wt.-%, more preferably of 17.0 to 20.0 wt.-%, based on the ethylene-1-hexene polymer component (B).

Even more preferably the multimodal polymer (P) of the invention is further multimodal with respect to difference in density between the ethylene polymer component (A) and ethylene polymer component (B). Preferably, the density of ethylene polymer component (A) is different, preferably higher, than the density of the ethylene polymer component (B).

The density of the ethylene polymer component (A) is in the range of 920 to 950 kg/m³, preferably of 925 to 950 kg/m³, more preferably 930 to 945 kg/m³ and/or the density of the ethylene polymer component (B) is of in the range of 880 to 915 kg/m³, preferably of 885 to 905 kg/m³ and more preferably of 888 to 900 kg/m³.

The polymer fraction (A-1) has a density in the range of from 920 to 960 kg/m³, preferably of 925 to 955 kg/m³, more preferably of 930 to 950 kg/m³, like 935 to 945 kg/m³.

The density of the polymer fraction (A-2) is in the range of from 930 to 950 kg/m³, preferably of 935 to 945 kg/m³.

The metallocene-catalysed multimodal copolymer (P) is preferably a linear low density polyethylene (LLDPE). The density of the multimodal copolymer (P) is in the range of 905 to 915 kg/m³, preferably of 908.0 to 915 kg/m³, more preferably of 910.0 to 915.0 kg/m³ and still more preferably of 911 to 914 kg/m³.

More preferably the multimodal copolymer (P) is multimodal at least with respect to, i.e. has a difference between, the MFR₂, the comonomer content as well as with respect to, i.e. has a difference between the density of the ethylene polymer components, (A) and (B), as defined above, below or in the claims including any of the preferable ranges or embodiments of the polymer composition.

Furthermore, the ethylene-1-butene polymer component (A) is preferably characterized by an isolated 1-butene comonomer unit amount of >95.0%, preferably at least 98.0% and more preferably 100%. The isolated comonomer unit amount is calculated according to equation (I)

$$EXE \% = 100 \times \frac{EXE}{EXE + EXX + XXX} \qquad ( I )$$

wherein X being the number of 1-butene branches per 1000 carbon (kCb).

In addition, the ethylene-1-hexene polymer component (B) preferably has an isolated 1-hexene comonomer unit amount according to equation (I), wherein X being the number of 1-hexene branches per 1000 carbon (kCb); fulfilling the equation (II)

$$EXE \% > - 1.1875 * C 6 ( of ( B ) in wt . - \% ) + 110.41 \qquad ( II )$$

Preferably, the ethylene-1-hexene polymer component (B) fulfils the equation

$$EXE \% > - 1.1875 * C 6 ( of ( B ) in wt . - \% ) + 111.41 , more preferably$$

$$EXE \% > - 1.1875 * C 6 ( of ( B ) in wt . - \% ) + 111.41 , \\ and even more preferably$$

$$EXE \% > - 1.1875 * C 6 ( of ( B ) in wt . - \% ) + 113.41 .$$

The isolated 1-hexene comonomer unit amount for component (B) is preferably >92.0%, preferably at least 93.0% and more preferably at least 94.0%. A suitable upper limit is <100%, preferably 99.0%, more preferably 98.0%.

It is within the scope of the invention, that the first and the second ethylene polymer fraction (A-1 and A-2) of the ethylene polymer component (A) are present in a weight ratio of 4:1 up to 1:4, such as 3:1 to 1:3, or 2:1 to 1:2, or 1:1.

The ethylene polymer component (A) is present in an amount of 30.0 to 70.0 wt.-% based on the multimodal copolymer (P), preferably in an amount of 32.0 to 55.0 wt.-% and even more preferably in an amount of 34.0 to 45.0 wt.-%.

Thus, the ethylene polymer component (B) is present in an amount of 70.0 to 30.0 wt.-% based on the multimodal copolymer (P), preferably in an amount of 68.0 to 45.0 wt.-% and more preferably in an amount of 66.0 to 55.0 wt.-%.

The metallocene-catalysed multimodal copolymer (P), can be produced in a 2-stage process, preferably comprising a slurry reactor (loop reactor), whereby the slurry (loop) reactor is connected in series to a gas phase reactor (GPR), whereby the ethylene polymer component (A) is produced in the loop reactor and the ethylene polymer component (B) is produced in GPR in the presence of the ethylene polymer component (A) to produce the multimodal copolymer (P).

In case that the ethylene component (A) of the multimodal copolymer (P) consists of ethylene polymer fractions (A-1) and (A-2), the multimodal copolymer (P) can be produced with a 3-stage process, preferably comprising a first slurry reactor (loop reactor 1), whereby the first slurry loop reactor is connected in series with another slurry reactor (loop reactor 2), so that the first ethylene polymer fraction (A-1) produced in the loop reactor 1 is fed to the loop reactor 2, wherein the second ethylene polymer fraction (A-2) is produced in the presence of the first fraction (A-1). The loop reactor 2 is thereby connected in series to a gas phase reactor (GPR), so that the first ethylene polymer component (A) leaving the second slurry reactor is fed to the GPR to produce a trimodal polyethylene copolymer. In this case, the reaction conditions in the two slurry reactors are chosen in a way that in the two slurry reactors different products in view of MFR and/or density are produced.

Such a process is described inter alia in WO 2016/198273 A1, WO 2021/009189 A1, WO 2021/009190 A1, WO 2021/009191 A1 and WO 2021/009192 A1. Full details of how to prepare suitable metallocene-catalysed multimodal copolymer (P) can be found in these references.

The metallocene-catalysed multimodal copolymer (P) is produced by using a metallocene catalyst. The metallocene catalyst preferably comprises a metallocene complex and a cocatalyst. The metallocene compound or complex is referred herein also as organometallic compound (C).

The organometallic compound (C) comprises a transition metal (M) of Group 3 to 10 of the Periodic Table (IUPAC 2007) or of an actinide or lanthanide.

The term “an organometallic compound (C)” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment, the organometallic compound (C) has the following formula (I):

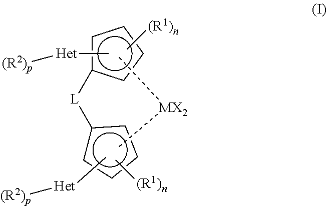

wherein each X is independently a halogen atom, a C₁₋₆-alkyl group, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₆-alkyl substituted with alkoxy having 1 to 10 carbon atoms; M is Ti, Zr or Hf;
each R¹ is the same or different and is a C₁₋₆-alkyl group or C₁₋₆-alkoxy group; each n is 1 to 2;
each R² is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and each p is 0 to 1.

Preferably, the compound of formula (I) has the structure

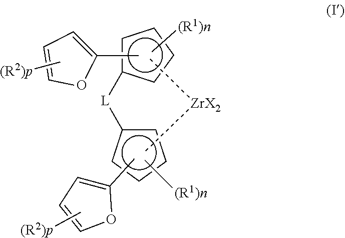

wherein each X is independently a halogen atom, a C₁₋₆-alkyl group, C₁₋₆-alkoxy group, phenyl or benzyl group;
L is a Me₂Si—;
each R¹ is the same or different and is a C₁₋₆-alkyl group, e.g. methyl or t-Bu;
each n is 1 to 2;
R² is a —Si(R)₃ alkyl group; each p is 1;
each R is C₁₋₆-alkyl or phenyl group.

Highly preferred complexes of formula (I) are

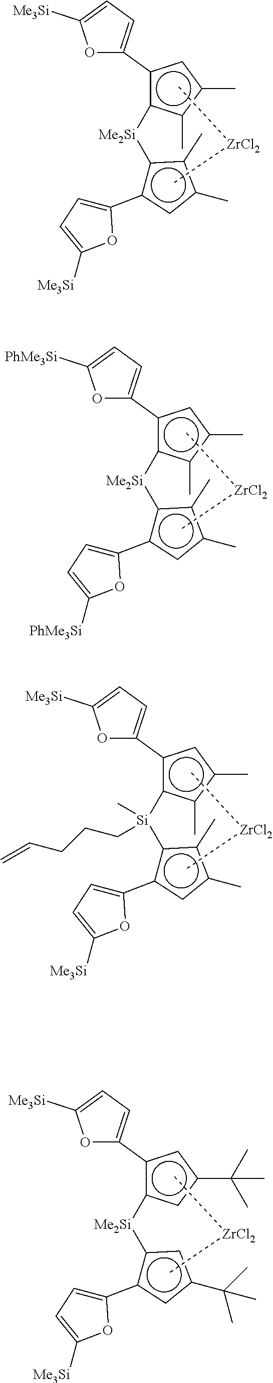

Most preferably the complex dimethylsilanediylbis[2-(5-trimethylsilylfuran-2-yl)-4,5-dimethylcyclopentadien-1-yl]zirconium dichloride is used.

More preferably the ethylene polymer components (A) and (B) of the multimodal copolymer (P) are produced using, i.e. in the presence of, the same metallocene catalyst.

To form a catalyst, a cocatalyst, also known as an activator, is used, as is well known in the art. Cocatalysts comprising Al or B are well known and can be used here. The use of aluminoxanes (e.g. MAO) or boron based cocatalysts (such as borates) is preferred.

Polyethylene copolymers made using single site catalysis, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

### Multi-Layered Article

The multi-layered article according to the present invention comprises at least an oriented polyethylene-based film (OPEF) and a non-oriented polyethylene-based film (NOPEF), wherein the non-oriented polyethylene-based film (NOPEF) comprises at least the following sublayers:
i) a skin layer (SKL);
ii) a core layer (CL); and
iii) a sealing layer (SL); wherein
the sealing layer comprises a metallocene-catalysed multimodal polyethylene copolymer (P), which consists of
30.0 to 70.0 wt.-% of an ethylene-1-butene polymer component (A), and
30.0 to 70.0 wt.-% of an ethylene-1-hexene polymer component (B), wherein
the ethylene-1-butene polymer component (A) has
a density (ASTM D792) in the range of 920 to 950 kg/m³;
a MFR₂ (190° C., 2.16 kg, ISO 1133) in the range of 2.0 to 200 g/10 min; and
a 1-butene content in the range of 0.5 to 5.0 wt.-%, based on the ethylene-1-butene polymer component (A); and
the ethylene-1-hexene polymer component (B) has
a density (ASTM D792) in the range of 880 to 915 kg/m³;
a MFR₂ (190° C., 2.16 kg, ISO 1133) in the range of 0.01 to 1.5 g/10 min; and
a 1-hexene content in the range of 15.0 to 25.0 wt.-% based on the ethylene-1-hexene polymer compound (B); wherein
the multimodal polyethylene copolymer (P) has
a density (ASTM D792) in the range of 905 to 915 kg/m³;
a MFR₂ (190° C., 2.16 kg, ISO 1133) in the range of 0.5 to below 2.0 g/10 min; and
a ratio of the MFR₂₁ (190° C., 21.6 kg, ISO 1133) to MFR₂ (190° C., 2.16 kg, ISO 1133), MFR₂₁/MFR₂, in the range of 22 to 70.

A preferred embodiment of the present invention stipulates that the oriented polyethylene-based film (OPEF) is produced according to a MDO—(Machine Direction Orientation) or BOPE-process (Biaxially Oriented Polyethylene) and preferably has a Tensile Modulus in MD (ISO 527-3) in the range of 1000 to 3000 MPa. The manufacture of biaxially oriented films is well known (e.g. chapter 2 and 3 in Biaxial stretching of film: principles and applications, editored by Mark T. DeMeuse, Woodhead Publishing, 2011). The manufacturing of MDO film is also well established. Generally speaking Machine direction orientation of plastic film and sheet is accomplished by heating the web and stretching it in the machine direction over a series of rollers. The device is commonly called a Machine Direction Orienter (MDO). Details can be found for example in Multilayer Flexible Packaging (Second Edition), 2016, Pages 147-152.

According to a further preferred embodiment according to the present invention the oriented polyethylene-based film (OPEF) has a thickness in the range of 10 to 100 μm; preferably in the range of 12 to 80 μm, more preferably 15 to 60 μm, still more preferably 20 to 40 μm and even more preferably in the range of 15 to 30 μm or 50 to 70 μm.

In another preferred embodiment of the present invention the non-oriented polyethylene-based film (NOPEF) has a thickness in the range of 15 to 160 μm; preferably in the range of 30 to 120 μm and more preferably in the range of 50 to 70 μm.

According to still another preferred embodiment of the present invention the skin layer (SKL) of the non-oriented polyethylene-based film (NOPEF) has a thickness in the range of 5 to 30 μm; preferably in the range of 8 to 25 μm and more preferably in the range of 10 to 15 μm.

In a further preferred embodiment of the present invention the core layer (CL) of the non-oriented polyethylene-based film (NOPEF) has a thickness in the range of 10 to 100 μm; preferably in the range of 20 to 80 μm and more preferably in the range of 30 to 45 μm.

Another preferred embodiment of the present invention stipulates that the sealing layer (SL) of the non-oriented polyethylene-based film (NOPEF) has a thickness in the range of 1 to 30 μm; preferably in the range of 8 to 25 μm and more preferably in the range of 10 to 15 μm.

According to a further preferred embodiment of the present invention the multi-layered article has a thickness in the range of 25 to 260 μm; preferably in the range of 40 to 150 μm and more preferably in the range of 80 to 90 μm.

It is furthermore preferred that the multi-layered article consists of polyethylene-based polymers.

According to a further preferred embodiment in accordance with the present invention the non-oriented polyethylene-based film (NOPEF) preferably consists of the skin layer (SKL), the core layer (CL) and the sealing layer (SL).

The skin layer (SKL) may comprise 70 to 100 wt.-%, more preferably 80 to 95 wt.-% and still more preferably 88 to 92 wt.-% based on the total weight of the skin layer (SKL) of a multimodal metallocene-catalysed linear low density polyethylene, being preferably a bimodal ethylene/1-butene/1-hexene terpolymer, preferably having a density (ASTM D792) in the range from 915 to 930 kg/m³, more preferably from 916 to 925 kg/m³ and a MFR₂ (190° C., 2.16 kg, ISO 1133) in the range from 0.5 to 2 g/10 min; and 0 to 30 wt.-%, preferably 5 to 20 wt.-%, more preferably 8 to 12 wt.-% based on the total weight of the skin layer (SKL) of a LDPE having a density (ASTM D792) in the range from 910 to 930 kg/m³, preferably from 920 to 925 kg/m³ and a MFR₂ (190° C., 2.16 kg, ISO 1133) in the range from 0.5 to 4 g/10 min and preferably from 1 to 2 g/10 min or 0.5 to 1.0 g/10 min.

The core layer (CL) preferably comprises 60 to 100 wt.-%, more preferably 70 to 99 wt.-% and still more preferably 75 to 85 wt.-% based on the total weight of the core layer (CL) of a Ziegler-Natta catalysed linear low density polyethylene being preferably a multimodal alpha-olefin terpolymer, preferably having a density (ASTM D792) in the range from 920 to 945 kg/m³, more preferably from 930 to 942 kg/m³ and still more preferably from 928 to 935 kg/m³ and a MFR₂ (190° C., 2.16 kg, ISO 1133) in the range from 0.5 to 2.5 g/10 min and preferably from 0.7 to 1.5 g/10 min; and 0 to 40 wt.-%, preferably 1 to 30 wt.-% and more preferably from 15 to 25 wt.-% based on the total weight of the core layer (CL) of a multimodal metallocene-catalysed linear low density polyethylene being preferably a bimodal ethylene/1-butene/1-hexene terpolymer, preferably having a density (ASTM D792) in the range from 910 to 930 kg/m³, more preferably from 916 to 925 kg/m³; and a MFR₂ (190° C., 2.16 kg, ISO 1133) in the range from 0.5 to 2 g/10 min.

The sealing layer (SL) preferably comprises 60 to 100 wt.-% or 65 to 90 wt.-%, more preferably 75 to 85 wt.-% based on the total weight of the sealing layer (SL) of the metallocene-catalysed multimodal polyethylene copolymer (P) having a density (ASTM D792) in the range from 910 to 915 kg/m³, preferably from 911 to 914 kg/m³ and a MFR₂ (190° C., 2.16 kg, ISO 1133) in the range from 0.5 to 1.8 g/10 min, preferably from 1.0 to 1.5 g/10 min; and 0 to 40 wt.-% or 10 to 35 wt.-%, preferably 15 to 25 wt.-% based on the total weight of the sealing layer (SL) of a plastomer, being preferably a copolymer of ethylene and 1-octene, preferably having a density (ASTM D792) in the range from 860 to 910 kg/m³, preferably from 895 to 905 kg/m³ and a MFR₂ (190° C., 2.16 kg, ISO 1133) in the range from 0.5 to 10 g/10 min, preferably from 1.0 to 1.5 g/10 min.

Still another preferred embodiment stipulates that the multi-layered article is a laminate, preferably consisting of the oriented polyethylene-based film (OPEF) and the non-oriented polyethylene-based film (NOPEF).

According to a further preferred embodiment in accordance with the present invention the multi-layered article has a Tensile Modulus in MD (ISO 527-3) in the range from 600 to 900, preferably 700 to 900 MPa and more preferably in the range from 750 to 820 MPa.

Another preferred embodiment according to the present invention stipulates that the multi-layered article has a Tensile Modulus in TD (ISO 527-3) in the range from 800 to 1100 MPa, preferably in the range from 900 to 1000 MPa.

Still another preferred embodiment stipulates that the multi-layered article has a Dart Drop Strength (ASTM D1709) in the range from 230 to 850 g, preferably from 240 to 700 g, more preferably from 240 to 600 g, still more preferably from 240 to 400 g and even more preferably in the range from 250 to 320 g.

In a further preferred embodiment in accordance with the present invention the multi-layered article has a Haze (ASTM D1003-00) in the range from 12 to 20%, preferably in the range from 15 to 18%.

Another preferred embodiment in accordance with the present invention stipulates that the multi-layered article has a Sealing Initiation Temperature determined as described in the specification in the range from 60 to 75° C., preferably in the range from 63 to 70° C.

Another preferred embodiment according to the present invention stipulates that the multi-layered article has a Protrusion (ASTM D5748) in the range of 150 to 300 N, preferably in the range of 159 to 200 g and more preferably in the range of 165 to 180 N.

The polymers used in the multi-layered article according to the present invention may contain additives and fillers and the used amounts thereof are conventional in the field of film applications. Examples of such additives are, among others, antioxidants, process stabilizers, UV-stabilizers, pigments, fillers, antistatic additives, antiblock agents, nucleating agents, acid scavengers as well as polymer processing agent (PPA).

It is understood herein that any of the additives and/or fillers can optionally be added in form of a so-called master batch, which comprises the respective additive(s) together with a carrier polymer. In such case the carrier polymer is not calculated to the polymer components of the metallocene-catalysed multimodal copolymer (P), but to the amount of the respective additive(s), based on the total amount of polymer composition (100 wt.-%).

### Method

Another aspect of the present invention relates to a method for producing the multi-layered article.

The multi-layered article may be obtained by laminating the oriented polyethylene-based film (OPEF) to the non-oriented polyethylene-based film (NOPEF). This may be affected in any conventional lamination device using conventional lamination methods, such as adhesive lamination, including both solvent-based and solvent-less adhesive lamination using any conventional, commercially available adhesive. Lamination may alternatively be carried out without any adhesive, as sandwich lamination with or without a melt web, which may be pressed between the substrates. Such melt web may be any conventional melt web material based on polyethylene, such as LDPE. Lamination may further be performed via extrusion coating technique. All these lamination methods are well known in the art and described in literature.

### Use

A further aspect of the present invention refers to the use of the multi-layered article as packaging material, preferably for food and/or medical products.

The invention will now be described with reference to the following non-limiting examples.

### Experimental Part

### A. Measuring Methods

The following definitions of terms and determination methods apply for the above general description of the invention as well as to the below examples unless otherwise defined.

### Melt Flow Rate

The melt flow rate (MFR) was determined according to ISO 1133—Determination of the melt mass-flow rate (MFR) and melt volume-flow rate (MVR) of thermoplastics—Part 1: Standard method and is indicated in g/10 min. The MFR is an indication of the flowability, and hence the processability, of the polymer. The higher the melt flow rate, the lower the viscosity of the polymer. The MFR of polyethylene is determined at a temperature of 190° C. and may be determined at different loadings such as 2.16 kg (MFR₂), 5 kg (MFR₅) or 21.6 kg (MFR₂₁).

Calculation of MFR₂ of Component B and of Fraction (a-2)

$$log A = x \cdot log B + ( 1 - x ) \cdot log C$$

$$C = 10 {\hat{}}^{\frac{( log A - x \cdot log B )}{( 1 - x )}}$$

For Component B:
B=MFR₂ of Component (A)
C=MFR₂ of Component (B)
A=final MFR₂ (mixture) of multimodal polyethylene copolymer (P)
X=weight fraction of Component (A)

For Fraction (A-2):
B=MFR₂ of 1^{st} fraction (A-1)
C=MFR₂ of 2^{nd} fraction (A-2)
A=final MFR₂ (mixture) of loop polymer (=Component (A))
X=weight fraction of the 1^{st} fraction (A-1).

### Density

Density of the polymers was measured according to ASTM D792, Method B (density by balance at 23° C.) on compression moulded specimen prepared according to EN ISO 1872-2 and is given in kg/m³.

### Dsc Analysis, Melting (Tm) and Crystallization Temperature (Tc)

Data were measured with a TA Instrument Q2000 differential scanning calorimetry (DSC) on 5 to 7 mg samples. DSC was run according to ISO 11357/part 3/method C2 in a heat/cool/heat cycle with a scan rate of 10° C./min in the temperature range of −30 to +225° C. Crystallization temperature (T_{c}) and crystallization enthalpy (H_{c}) were determined from the cooling step, while melting temperature (Tₘ) and melting enthalpy (Hₘ) are determined from the second heating step.

### Haze

The haze was determined according to ASTM D1003-00 on films as described below (non-oriented films, oriented films and laminates).

### Dart Drop Strength (DDI): Impact Resistance by Free-Falling Dart Method

The DDI was measured according to ISO 7765-1:1988/Method A from the films (non-oriented films and laminates) as produced indicated below. This test method covers the determination of the energy that causes films to fail under specified conditions of impact of a free-falling dart from a specified height that would result in failure of 50% of the specimens tested (Staircase method A). A uniform missile mass increment is employed during the test and the missile weight is decreased or increased by the uniform increment after test of each specimen, depending upon the result (failure or no failure) observed for the specimen.

### Standard Conditions:

Conditioning time: >96 h
Test temperature: 23° C.
Dart head material: phenolic
Dart diameter: 38 mm
Drop height: 660 mm

### Results:

Impact failure weight—50% [g]

### Tensile Modulus (TM)

Tensile modulus (MPa) was measured in machine (MD) and transverse direction (TD) according to ISO 527-3 on film samples (non-oriented films, oriented films and laminates) prepared as described below and at a cross head speed of 1 mm/min.

### Sealing Initiation Temperature (SIT); Sealing End Temperature (SET), Sealing Range

The method determines the sealing temperature range (sealing range) of polyethylene films, in particular blown films, cast films or laminates. The sealing temperature range is the temperature range, in which the films can be sealed according to conditions given below.

The lower limit (heat sealing initiation temperature (SIT)) is the sealing temperature at which a sealing strength of 5 N is achieved. The upper limit (sealing end temperature (SET)) is reached, when the films stick to the sealing device.

The measurement was done according to the slightly modified ASTM F1921-12, where the test parameters sealing pressure, cooling time and test speed have been modified. The determination of the force/temperature curve was continued until thermal failure of the film.

The sealing range was determined on a J&B Universal Sealing Machine Type 4000 with a film produced as described below (non-oriented film and laminate) with the following further parameters:
Conditioning time: >96 h
Specimen width: 25 mm
Sealing pressure: 0.4 N/mm² (PE)
Sealing time: 1 sec
Delay time: 30 sec
Sealing jaws dimension: 50×5 mm
Sealing jaws shape: flat
Sealing jaws coating: Niptef
Sealing temperature: ambient−240° C.
Sealing temperature interval: 5° C.
Start temperature: 50° C.
Grip separation rate: 42 mm/see

### Comonomer Contents—Quantification of Microstructure by NMR Spectroscopy

Quantitative nuclear-magnetic resonance (NMR) spectroscopy was used to quantify the comonomer content of the polymers.

Quantitative ¹³C{¹H}NMR spectra were recorded in the molten-state using a Bruker Avance III 500 NMR spectrometer operating at 500.13 and 125.76 MHz for ¹H and ¹³C respectively. All spectra were recorded using a ¹³C optimized 7 mm magic-angle spinning (MAS) probehead at 150° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification {klimke06, parkinson07, castignolles09}. Standard single-pulse excitation was employed utilizing the NOE at short recycle delays of 3 s {pollard04, klimke06} and the RS-HEPT decoupling scheme{fillip05,griffinO7}. A total of 1024 (1k) transients were acquired per spectra.

Quantitative ¹³C{¹H}NMR spectra were processed, integrated and relevant quantitative properties determined from the integrals. All chemical shifts are internally referenced to the bulk methylene signal (δ+) at 30.00 ppm.

The amount of ethylene was quantified using the integral of the methylene (δ+) sites at 30.00 ppm accounting for the number of reporting sites per monomer:

$$E = {I}_{δ +} / 2$$

the presence of isolated comonomer units is corrected for based on the number of isolated comonomer units present:

$$Etotal = E + ( {3}^{*} B + {2}^{⋆} H ) / 2$$

where B and H are defined for their respective comonomers. Correction for consecutive and non-consecutive commoner incorporation, when present, is undertaken in a similar way.

Characteristic signals corresponding to the incorporation of 1-butene were observed and the comonomer fraction calculated as the fraction of 1-butene in the polymer with respect to all monomer in the polymer:

$$fBtotal = Btotal / ( Etotal + Btotal + Htotal )$$

The amount isolated 1-butene incorporated in EEBEE sequences was quantified using the integral of the _{*}B2 sites at 39.8 ppm accounting for the number of reporting sites per comonomer:

$$B = {I}_{* B 2}$$

If present the amount consecutively incorporated 1-butene in EEBBEE sequences was quantified using the integral of the ααB2B2 site at 39.4 ppm accounting for the number of reporting sites per comonomer:

$$B B = {2}^{⋆} I αα B 2 B 2$$

If present the amount non-of reporting sites per comonomer:

$$HEH = {2}^{⋆} I ββ B 4 B 4$$

Sequences of HHH were not observed. The total 1-hexene content was calculated based on the sum of isolated, consecutive and non consecutively incorporated 1-hexene:

$$Htotal = H + H H + H E H$$

The total mole fraction of 1-hexene in the polymer was then calculated as:

$$fH = Htotal / ( Etotal + Btotal + Htotal )$$

The mole percent comonomer incorporation is calculated from the mole fraction:

$$B [ mol \% ] = 10 {0}^{⋆} fB$$

$$H [ mol \% ] = 10 {0}^{⋆} fH$$

The weight percent comonomer incorporation is calculated from the mole fraction:

$$B [ wt . - \% ] = 10 {0}^{⋆} ( f {B}^{⋆} 56.11 ) / ( ( f {B}^{⋆} 56.11 ) + ( f {H}^{⋆} 84.16 ) + ( {( 1 - ( fB + f H ) )}^{⋆} 28.05 ) )$$

$$H [ wt . - \% ] = 10 {0}^{⋆} ( f {H}^{⋆} 84.16 ) / ( ( f {B}^{⋆} 56.11 ) + ( f {H}^{⋆} 84.16 ) + ( {( 1 - ( fB + f H ) )}^{⋆} 28.05 ) )$$

### REFERENCES

Klimke, K., Parkinson, M., Piel, C., Kaminsky, W., Spiess, H. W., Wilhelm, M., Macromol. Chem. Phys. 2006; 207:382.
Parkinson, M., Klimke, K., Spiess, H. W., Wilhelm, M., Macromol. Chem. Phys. 2007; 208:2128. Pollard, M., Klimke, K., Graf, R., Spiess, H. W., Wilhelm, M., Sperber, O., Piel, C., Kaminsky, W., Macromolecules 2004; 37:813.
Filip, X., Tripon, C., Filip, C., J. Mag. Resn. 2005, 176, 239.
Griffin, J. M., Tripon, C., Samoson, A., Filip, C., and Brown, S. P., Mag. Res. in Chem. 2007 45, S1, S198.
Castignolles, P., Graf, R., Parkinson, M., Wilhelm, M., Gaborieau, M., Polymer 50 (2009) 2373.
Busico, V., Cipullo, R., Prog. Polym. Sci. 26 (2001) 443.
Busico, V., Cipullo, R., Monaco, G., Vacatello, M., Segre, A. L., Macromoleucles 30 (1997) 6251.
Zhou, Z., Kuemmerle, R., Qiu, X., Redwine, D., Cong, R., Taha, A., Baugh, D. Winniford, B., J. Mag. Reson. 187 (2007) 225.
Busico, V., Carbonniere, P., Cipullo, R., Pellecchia, R., Severn, J., Talarico, G., Macromol. Rapid Commun. 2007, 28, 1128.
Resconi, L., Cavallo, L., Fait, A., Piemontesi, F., Chem. Rev. 2000, 100, 1253.

### Protrusion

Protrusion Puncture Resistance testing was conducted according to ASTM D5748 on films (laminates) manufactured as described below. The Puncture Resistance Force (N) is the maximum force or highest force observed during the test and Puncture Resistance Energy (J) is the energy used until the probe breaks the test specimen, both were measured using the high accuracy 500 N loadcell and crosshead position sensor.

### B. Materials Used

### HDPE

FB5600 is a bimodal high density polyethylene (MFR₂ (190° C./2.16 kg): 0.70 g/10 min, density: 960 kg/m³, Tₘ 132° C.) commercially available as Borstar® FB5600 from Borouge.

### LDPE

FT5236 is a low density polyethylene (MFR₂ (190° C./2.16 kg): 0.75 g/10 min, density: 923 kg/m³, Tₘ 112° C., produced by Tubular Technology) commercially available as FT5236 from Borealis AG and contains anti-block, antioxidant and slip additives.

### Multimodal Metallocene-Catalysed Linear Low Density Polyethylene

FK1820 is a bimodal ethylene/1-butene/1-hexene terpolymer (MFR₂ (190° C./2.16 kg): 1.5 g/10 min, density: 918 kg/m³, Tₘ 122° C., produced with a metallocene catalyst) commercially available as Anteo™ FK1820 from Borouge and contains antioxidant and processing aid.

### Ziegler-Natta Catalysed Linear Low Density Polyethylenes

FX1001 is a multimodal alpha-olefin terpolymer (MFR₅ (190° C./5 kg): 0.9 g/10 min, density: 931 kg/m³, Tₘ 127° C., produced with a Ziegler-Natta catalyst) commercially available as BorShape™ FX1001 from Borealis AG and contains antioxidant.

FX1002 is a multimodal alpha-olefin terpolymer (MFR₅ (190° C./5 kg): 2.0 g/10 min, density: 937 kg/m³, Tₘ 128° C., produced with a Ziegler-Natta catalyst) commercially available as BorShape™ FX1002 from Borealis AG and contains antioxidant.

### Plastomer

Queo0201 is an unimodal ethylene based 1-octene plastomer (MFR₂ (190° C./2.16 kg): 1.1 g/10 min, density: 902 kg/m³, Tₘ 97° C., produced in a solution polymerization process using a metallocene catalyst, commercially available as Queo™ 0201 from Borealis AG and contains processing stabilizers.

Slip MB is commercially available as POLYBATCH® CE-505-E from A. Schulman and is a 5 wt.-% erucamide slip concentrate in polyethylene which has a MFR₂ of 20 g/10 min.

Antiblock is commercially available as POLYBATCH® FSU-105-E from A. Schulman and is a general purpose erucamide slip and antiblock concentrate in LDPE which has a MFR₂ of 13 g/10 min.

Metallocene-catalysed multimodal polyethylene copolymer (P) was prepared as follows:

### Catalyst Preparation (CAT)

### Loading of SiO2:

10 kg of silica (PQ Corporation ES757, calcined 600° C.) was added from a feeding drum and inertized in a reactor until O₂ level below 2 ppm was reached.

### Preparation of MAO/tol/MC:

30 wt.-% MAO in toluene (14.1 kg) was added into another reactor from a balance followed by toluene (4.0 kg) at 25° C. (oil circulation temp) and stirring 95 rpm. Stirring speed was increased 95 rpm->200 rpm after toluene addition, stirring time 30 minutes. Metallocene Rac-dimethylsilanediylbis{2-(5-(trimethylsilyl)furan-2-yl)-4,5-dimethylcyclopentadien-1-yl}zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst:

Reactor temperature was set to 10° C. (oil circulation temp) and stirring was turned to 40 rpm during MAO/tol/MC addition. MAO/tol/MC solution (22.2 kg) was added within 205 minutes followed by 60 minutes stirring time (oil circulation temp was set to 25° C.). After stirring “dry mixture” was stabilised for 12 hours at 25° C. (oil circulation temp) without stirring. Reactor was turned 20° (back and forth) and stirring was turned on 5 rpm for few rounds once an hour.

After stabilisation the catalyst was dried at 60° C. (oil circulation temp) for 2 hours under nitrogen flow 2 kg/h, followed by 13 hours under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

### Polymerization:

The polymerization was carried out in a Borstar pilot plant with a 3-reactor set-up (loop 1-loop 2-GPR) and a prepolymerization loop reactor according to the conditions as given in Table 1.

TABLE 1
Polymerization conditions.

| Prepoly reactor | |
|---|---|
| Catalyst | CAT |
| Catalyst feed (g/h) | 35 |
| Temperature (° C.) | 50 |
| Pressure (kPa) | 5639 |
| C2 (kg/h) | 4.0 |
| H2 (g/h) | 0.04 |
| C4 (g/h) | 81.9 |
| Split (wt.-%) | 3.4 |
| loop 1 Fraction (A-1) | |
| Temperature (° C.) | 85 |
| Pressure (kPa) | 5544 |
| C2 conc. (mol %) | 3.5 |
| H2/C2 ratio (mol/kmol) | 0.41 |
| C4/C2 ratio (mol/kmol) | 41 |
| Split (wt.-%) | 17.6 |
| Density (kg/m³) of loop 1 material (fraction (A-1)) | 941 |
| MFR₂ (g/10 min) of loop 1 material (fraction (A-1)) | 5.0 |
| loop 2 | |
| Temperature (° C.) | 85 |
| Pressure (kPa) | 5325 |
| C2 conc. (mol %) | 3.5 |
| H2/C2 ratio (mol/kmol) | 0.6 |
| C4/C2 ratio (mol/kmol) | 29 |
| Split (wt.-%) | 20.4 |
| Density (kg/m³) after loop 2 (component (A)) | 940.7 |
| MFR₂ (g/10 min) after loop 2 (component (A)) | 5.8 |
| MFR₂ (g/10 min) of loop 2 material (fraction (A-2)) | 6.8 |
| Density (kg/m³) of loop 2 material (fraction (A-2)) | 941 |
| C4 (wt.-%) after loop 2 material (Component (A)) | 1.21 |
| GPR | |
| Temperature (° C.) | 75.0 |
| Pressure (kPa) | 2000.0 |
| H2/C2 ratio (mol/kmol) | 1.18 |
| C6/C2 ratio (mol/kmol) | 14.5 |
| Split (wt.-%) | 58.6 |
| MFR₂ (g/10 min) of GPR material (Component (B)) | 0.5 |
| Density (kg/m³) of GPR material (Component (B)) | 891 |
| C6 (wt.-%) of GPR material (Component (B)) | 18.60 |

The metallocene-catalysed multimodal polyethylene copolymer (P) was mixed with 2400 ppm of Irganox B561 (commercially available from BASE) and 270 ppm of Dynamar FX 5922 (commercially available from 3 M), compounded and extruded under nitrogen atmosphere to pellets by using a JSW extruder so that the SEI was 230 kWh/kg and the melt temperature 250° C. The properties of (P) are summarized in Table 2 below.

TABLE 2
Properties of metallocene-catalysed multimodal
polyethylene copolymer (P).

| Properties | Unit | IE1 |
|---|---|---|
| MFR₂ | g/10 min | 1.3 |
| MFR₂₁ | g/10 min | 38.7 |
| MFR₂₁/MFR₂ | — | 29.8 |
| Density | kg/m3 | 913 |
| C4 | wt.-% | 0.5 |
| C6 | wt.-% | 10.7 |
| MFR₂(A)/MFR₂ | — | 4.5 |
| EBE | kCb | 1.3 |
| EBB | kCb | 0 |
| BBB | kCb | 0 |
| EBE | % | 100 |
| EHE | kCb | 16 |
| EHH | kCb | 0.9 |
| HHH | kCb | 0 |
| EHE | % | 94.7 |

### C. Manufacturing of Films and Laminates

The 5 layer MDO film (OPEF) was produced as follows.

A start blown film was produced on a Alpine 7 semi-commercial line. The recipe of the film is shown in Table 3. The thickness of the start film was 150 μm, BUR 1: 2.5, melt temperature 220° C. This film was stored at 23° C. for 24 h, then it was stretched on an Alpine MDO 20 pilot line. The stretching ratio was 1:6.0 and the stretching roll temperature 122° C. The final film had a thickness of 25 μm, a haze of 7.7% and a Tensile Modulus (MD) of 2514 MPa. To reach a surface energy of at least 38 dynes the side for lamination was Corona-treated.

TABLE 3
5 layer MDO film (OPEF).

| Layer | Material (content in wt.-%) | Layer distribution (%) |
|---|---|---|
| 1 | FB5600 (100) | 15 |
| 2 | FX1002 (70) + FB5600 (30) | 10 |
| 3 | FX1002 (100) | 50 |
| 4 | FX1002 (70) + FB5600 (30) | 10 |
| 5 | FB5600 (100) | 15 |

Furthermore, three non-oriented films (see composition and properties in Table 4) produced as follows. The films were produced on an Alpine 7 semi-commercial line with a BUR of 1:2.5, film thickness 60 μm. The line conditions were adjusted to ensure a smooth production, e.g. a film thickness distribution <5%. The recipe of the films and properties of the films are in Table 4. To reach a surface energy of at least 38 dynes the side for lamination was Corona-treated.

Finally, laminates of the MDO film shown in Table 3 and the non-oriented films according to Table 4 were produced. The skin layer was laminated to the MDO film. The lamination was conducted on a lab scale on a solvent-less laminator at a running speed of 150 m/min with an adhesive content of 1.8 g/m². The adhesive used was LA7825 and hardener LA6230 (both supplied by Henkel), mixed at a 2:1 ratio. The corona treatment intensity on the carrier web was 2.5 kW and on the secondary web 1.5 kW.

### D. Results

TABLE 4
Composition and properties of non-oriented films and laminates.

| | | |
|---|---|---|
| IE1 | IE2 | CE1 |

Non-oriented film (NOPEF) - composition

| | | | | |
|---|---|---|---|---|
| Skin layer (12 μm) | FK1820 [wt.-%] | 18 | 18 | 18 |
| | FT5236 [wt.-%] | 2 | 2 | 2 |
| Core layer (36 μm) | FX1001 [wt.-%) | 48 | 48 | 48 |
| | FK1820 [wt.-%] | 12 | 12 | 12 |
| Seal layer (12 μm) | P [wt.-%] | 19 | 15 | — |
| | Queo 0201 [wt.-%] | — | 4 | 12 |
| | Slip MB [wt.-%] | 0.5 | 0.5 | 0.5 |
| | Antiblock [wt.-%] | 0.5 | 0.5 | 0.5 |
| | FK1820 [wt.-%] | — | — | 7 |

Non-oriented film (NOPEF) - properties

| | | | | |
|---|---|---|---|---|
| TM (MD) | MPa | 367 | 361 | 362 |
| TM (TD) | MPa | 464 | 465 | 462 |
| DDI | G | 654 | 612 | 720 |
| Haze | % | 15 | 14 | 13 |
| SIT | ° C. | 68 | 69 | 78 |

Laminates - properties

| | | | | |
|---|---|---|---|---|
| TM (MD) | MPa | 771 | 805 | 783 |
| TM (TD) | MPa | 927 | 942 | 939 |
| DDI | g | 266 | 301 | 225 |
| Haze | % | 17 | 16 | 14 |
| SIT | ° C. | 66 | 67 | 77 |
| Protrusion | N | 167 | 176 | 157 |

wt.-% based on the total weight of the non-oriented film.

### E. Discussion of the Results

The laminates according to the present invention (IE1 and IE2) have the same skin layer and the same core layer as the laminate according to the comparative example (CE1). The laminates according to IE1 and IE2 differ to the laminate according to CE1 with regard to the polymer used in the sealing layer.

As can be gathered from above Table 4 the laminates according to the present invention do not only show better stiffness and toughness (expressed by the Tensile Modules, Dart Drop Strength and Protrusion), but also show better sealing properties (lower SIT) and have a comparable haze.

1. A multi-layered article comprising at least an oriented polyethylene-based film (OPEF) and a non-oriented polyethylene-based film (NOPEF), wherein
the non-oriented polyethylene-based film (NOPEF) comprises at least the following sublayers:
i) a skin layer (SKL);
ii) a core layer (CL); and
iii) a sealing layer (SL); wherein
the sealing layer comprises a metallocene-catalyzed multimodal polyethylene copolymer (P), which consists of
30.0 to 70.0 wt.-% of an ethylene-1-butene polymer component (A), and
30.0 to 70.0 wt.-% of an ethylene-1-hexene polymer component (B), wherein
the ethylene-1-butene polymer component (A) has
a density (ASTM D792) in the range of 920 to 950 kg/m³;
a MFR₂ (190° C., 2.16 kg, ISO 1133) in the range of 2.0 to 200.0 g/10 min; and
a 1-butene content in the range of 0.5 to 5.0 wt.-%, based on the ethylene-1-butene polymer component (A); and
the ethylene-1-hexene polymer component (B) has
a density (ASTM D792) in the range of 880 to 915 kg/m³;
a MFR₂ (190° C., 2.16 kg, ISO 1133) in the range of 0.01 to 1.5 g/10 min; and
a 1-hexene content in the range of 15.0 to 25.0 wt.-% based on the ethylene-1-hexene polymer component (B); wherein
the multimodal polyethylene copolymer (P) has
a density (ASTM D792) in the range of from 905 to 915 kg/m³;
a MFR₂ (190° C., 2.16 kg, ISO 1133) in the range of 0.5 to below 2.0 g/10 min; and
a ratio of the MFR₂₁ (190° C., 21.6 kg, ISO 1133) to MFR₂ (190° C., 2.16 kg, ISO 1133), MFR₂₁/MFR₂, in the range of 22 to 70.

2. The multi-layered article according to claim 1, characterized in that the oriented polyethylene-based film (OPEF) is produced according to a MDO-process (Machine Direction Orientation) or BOPE-process (Biaxially Oriented Polyethylene).

3. The multi-layered article according to claim 1, characterized in that;
the oriented polyethylene-based film (OPEF) has a thickness in the range of 10 to 100 μm; and/or
the non-oriented polyethylene-based film (NOPEF) has a thickness in the range of 15 to 160 μm; and/or
the skin layer (SKL) of the non-oriented polyethylene-based film (NOPEF) has a thickness in the range of 5 to 30 μm; and/or
the core layer (CL) of the non-oriented polyethylene-based film (NOPEF) has a thickness in the range of 10 to 100 μm; and/or
the sealing layer (SL) of the non-oriented polyethylene-based film (NOPEF) has a thickness in the range of 1 to 30 μm; and/or
the multi-layered article has a thickness in the range of 25 to 260 μm; and/or
the multi-layered article consists of polyethylene-based polymers.

4. The multi-layered article according to claim 1, characterized in that the non-oriented polyethylene-based film (NOPEF) consists of the skin layer (SKL), the core layer (CL) and the sealing layer (SL).

5. The multi-layered article according to claim 1, characterized in that the core layer (CL) comprises:
60 to 100 wt.-%, based on the total weight of the core layer (CL) of a Ziegler-Natta catalyzed linear low density polyethylene; and
0 to 40 wt.-%, based on the total weight of the core layer (CL) of a multimodal metallocene-catalyzed linear low density polyethylene.

6. The multi-layered article according to claim 1, characterized in that the sealing layer (SL) comprises
60 to 100 wt.-% based on the total weight of the sealing layer (SL) of the metallocene-catalyzed multimodal polyethylene copolymer (P) having a density (ASTM D792) in the range from 910 to 915 kg/m³; and
0 to 40 wt.-% based on the total weight of the sealing layer (SL) of a plastomer.

7. The multi-layered article according to claim 1, characterized in that said multi-layer article is a laminate.

8. The multi-layered article according to claim 1, characterized in that the multimodal polyethylene copolymer (P) has:
an isolated 1-butene comonomer unit amount of >95% in component (A), whereby the isolated 1-butene comonomer unit amount is calculated according to equation (I)
$$EXE \% = 100 \times \frac{EXE}{EXE + EXX + XXX} \qquad ( I )$$
X being the number of 1-butene branches per 1000 carbon (kCb); and
an isolated 1-hexene comonomer unit amount according to formula (I) in component (B), wherein X being the number of 1-hexene branches per 1000 carbon (kCb); fulfilling equation (II)
$$EXE \% > - 1.1875 * C 6 ( of ( B ) in wt . - \% ) + 110.41 . \qquad ( II )$$

9. The multi-layered article according to claim 1, characterized in that component (A) of the metallocene-catalyzed multimodal polyethylene copolymer (P) consists of an ethylene polymer fraction (A-1) and an ethylene polymer fraction (A-2).

10. The multi-layered article according to claim 1, characterized in that the metallocene-catalyzed multimodal copolymer (P) has:
a ratio of the MFR₂₁ (190° C., 21.6 kg, ISO 1133) to MFR₂ (190° C., 2.16 kg, ISO 1133), MFR₂₁/MFR₂ is in the range from 23 to 50; and/or
the total amount of 1-butene, based on the multimodal polymer (P) is in the range from 0.1 to 2.5 wt.-%; and/or
the total amount of 1-hexene, based on the multimodal polymer (P) is in the range from 2.0 to 20.0 wt.-%.

11. The multi-layered article according to claim 1, characterized in that the metallocene-catalyzed multimodal copolymer (P) is produced in the presence of a metallocene complex of formula (I): 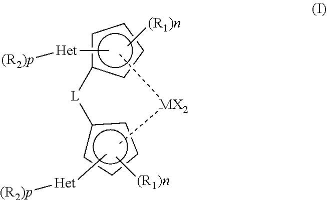
wherein
each X is independently a halogen atom, a C₁₋₆-alkyl group, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R₁ is the same or different and is a C₁₋₆-alkyl group or C₁₋₆-alkoxy group;
each n is 1 to 2;
each R₂ is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

12. The multi-layered article according to claim 1, characterized in that said multi-layered article has:
a Tensile Modulus in MD (ISO 527-3) in the range from 600 to 900 MPa; and/or
a Tensile Modulus in TD (ISO 527-3) in the range from 800 to 1100 MPa; and/or
a Dart Drop Strength (ASTM D1709) in the range from 230 to 850 g.

13. The multi-layered article according to claim 1, characterized in that said multi-layered article has:
a Haze (ASTM D1003-00) in the range from 12 to 20%; and/or
a Sealing Initiation Temperature determined as described in the specification in the range from 60 to 75° C.; and/or
a Protrusion (ASTM D5748) in the range from 150 to 300 N.

14. A method for producing the multi-layered article according to claim 1.

15. A method of use of the multi-layered article according to claim 1 as packaging material.

16. The multi-layered article according to claim 1, characterized in that the oriented polyethylene-based film (OPEF) has a Tensile Modulus in MD (ISO 527-3) in the range of 1000 to 3000 MPa.

17. The multi-layered article according to claim 1, wherein the skin layer (SKL) preferably comprises
70 to 100 wt.-%, based on the total weight of the skin layer (SKL), of a multimodal metallocene-catalyzed linear low density polyethylene; and
0 to 30 wt.-%, based on the total weight of the skin layer (SKL), of a LDPE having a density (ASTM D792) in the range from 910 to 930 kg/m³ and a MFR₂ (190° C., 2.16 kg, ISO 1133) in the range from 0.5 to 4 g/10 min.

18. The multi-layered article according to claim 9, wherein:
the ethylene polymer fraction (A-1) has:
a density (ASTM D792) in the range from 920 to 960 kg/m³; and/or
a MFR₂ (190° C., 2.16 kg, ISO 1133) in the range from 1.0 to 20.0 g/10 min;
and/or
the ethylene polymer fraction (A-2) has:
a density (ASTM D792) in the range from 930 to 950 kg/m³, and
a MFR₂ (190° C., 2.16 kg, ISO 1133) the range of 3.0 to 40.0 g/10 min.
